(19) United States
(12) Patent Application Publication
(10) Pub. No.: US 2026/0336074 A1
(43) Pub. Date: Oct. 29, 2026

(54) Torque Structure

(71) Applicant: Wen-Chin Kuo, Taichung City (TW)

(72) Inventor: Wen-Chin Kuo, Taichung City (TW)

(21) Appl. No.: 19/192,391

(22) Filed: Apr. 29, 2025

(51) Int. Cl. B25B 23/14; B25B 13/46; B25B 23/00; B25B 23/142

(52) U.S. Cl. CPC B25B 23/141; B25B 13/465; B25B 23/0007; B25B 23/1422

(57) ABSTRACT

A torque structure includes a first body, a second body, a third body unit, and a movement unit. The first body has a first receiving recess. The second body unit includes a second body, a threaded seat, a threaded rod, a screw member, and an elastic member. The second body has a first threaded portion. The threaded seat has a second threaded portion. The threaded rod has a third threaded portion screwed. The screw member is screwed onto the third threaded portion and rests on the threaded seat. The third body unit includes a third body and a rotation member. The third body has a fourth threaded portion. The rotation member has a first outer peripheral face, a first inner peripheral face, multiple first protruded portions, and multiple first recessed portions. The movement unit includes a moving member, a first ball, and a second ball.

### BACKGROUND OF THE INVENTION

### Field of the Invention

The present invention relates to a hand operated tool and, more particularly, to a torque structure, such as a torque wrench or the like.

### Description of the Related Art

A conventional torque wrench with constant torque was disclosed in the U.S. Pat. No. 9,089,957, and comprises a wrench body 10, an adapter 20, a pillar 30, a clutch member 40, a handle 50, and a resilient member 60. However, such a conventional torque wrench has the following disadvantage. The tube 11 and the head 12 form an integral structure. The tube 11 has an interior formed with a through hole for receiving the clutch member 40 and the handle 50. It is difficult to work the tube 11 to form the through hole having a determined length, thereby complicating the working process, and thereby increasing the cost of fabrication.

### BRIEF SUMMARY OF THE INVENTION

In accordance with the present invention, there is provided a torque structure comprising a first body, a second body, a third body unit, and a movement unit. The first body is provided with a first receiving recess. The second body unit includes a second body, a threaded seat, a threaded rod, a screw member, and an elastic member. The second body is provided with a first threaded portion. The threaded seat is provided with a second threaded portion. The threaded rod is provided with a third threaded portion screwed. The screw member is screwed onto the third threaded portion and rests on the threaded seat. The third body unit includes a third body and a rotation member. The third body is provided with a fourth threaded portion. The rotation member is provided with a first outer peripheral face, a first inner peripheral face, multiple first protruded portions, and multiple first recessed portions. The movement unit includes a moving member, a first ball, and a second ball. The moving member is provided with a first abutting portion and a second abutting portion.

According to the primary advantages of the present invention, the third body unit is assembled with the second body unit. The second body is a hollow tube that is worked easily. The second body is only worked to form the first threaded portion and the first through holes, thereby reducing the working cost.

According to another advantage of the present invention, the third body is only worked to form the fourth threaded portion that is screwed into the first threaded portion. Thus, the fourth threaded portion is assembled with the first threaded portion quickly.

According to a further advantage of the present invention, the second ball rests against the elastic member. The elastic member has a ring shape so that the second ball aligns with the elastic member easily. Thus, the axis of the movement unit aligns with that of the elastic member easily, to reduce an axis deviation between the movement unit and the elastic member, and to prevent an error of torque.

According to a further advantage of the present invention, after the second body unit and the third body unit are assembled, the threaded rod is rotated to adjust the torque. When the torque is adjusted to the required value, the screw member is screwed onto the third threaded portion of the threaded rod. Thus, the screw member presses the threaded seat, so that the threaded rod is positioned and cannot be rotated to adjust the torque anymore. Then, the second body unit is mounted in the first body to construct the torque structure with a constant torque.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a torque structure in accordance with the preferred embodiment of the present invention.

FIG. 2 is an exploded perspective view of a second body unit of the torque structure in accordance with the preferred embodiment of the present invention.

FIG. 3 is a perspective assembly view of the second body unit of the torque structure in accordance with the preferred embodiment of the present invention.

FIG. 4 is a top view of the second body unit of the torque structure in accordance with the preferred embodiment of the present invention.

FIG. 5 is a cross-sectional view of the second body unit taken along line A-A as shown in FIG. 4.

FIG. 6 is an exploded perspective view of a third body unit of the torque structure in accordance with the preferred embodiment of the present invention.

FIG. 7 is a perspective view of a rotation member of the torque structure in accordance with the preferred embodiment of the present invention.

FIG. 8 is an exploded perspective view of a movement unit of the torque structure in accordance with the preferred embodiment of the present invention.

FIG. 9 is a perspective view of the torque structure in accordance with the preferred embodiment of the present invention.

FIG. 10 is a side view of the torque structure in accordance with the preferred embodiment of the present invention.

FIG. 11 is a cross-sectional view of the torque structure taken along line B-B as shown in FIG. 10.

FIG. 12 is a schematic perspective view showing operation of the torque structure in accordance with the preferred embodiment of the present invention.

### DETAILED DESCRIPTION OF THE INVENTION

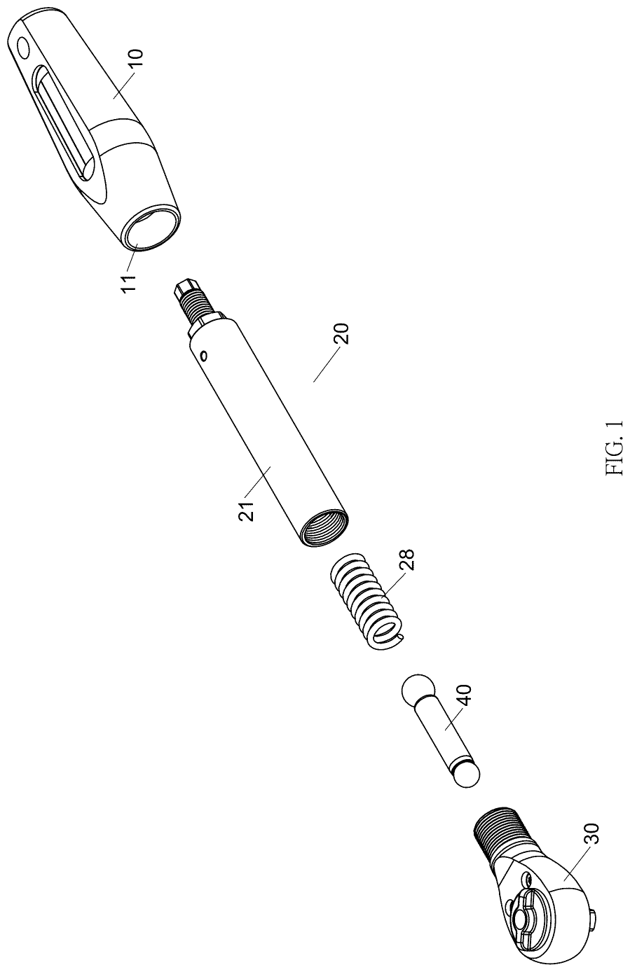

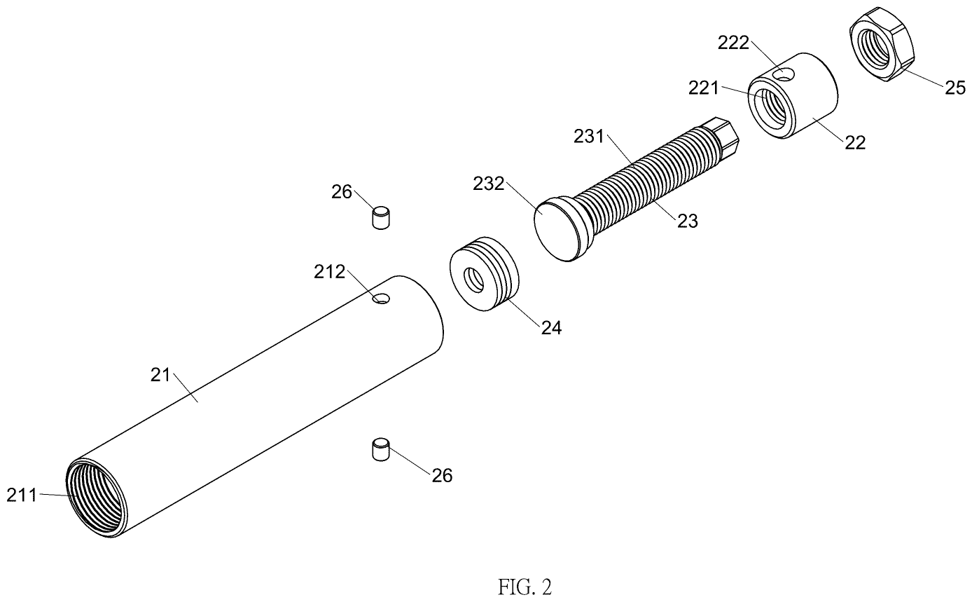

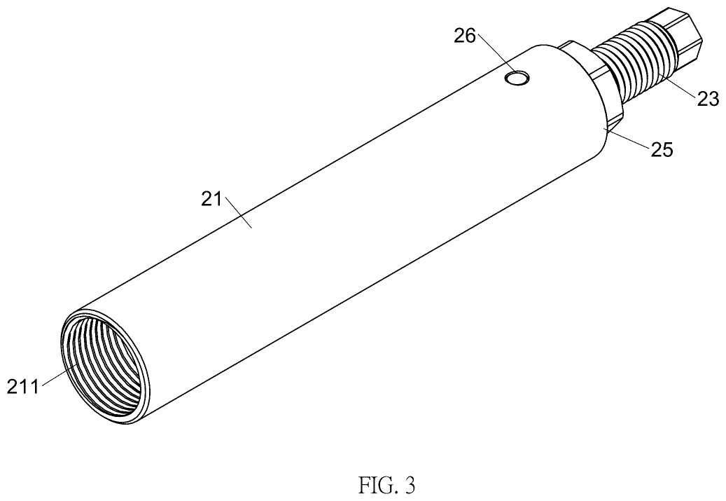

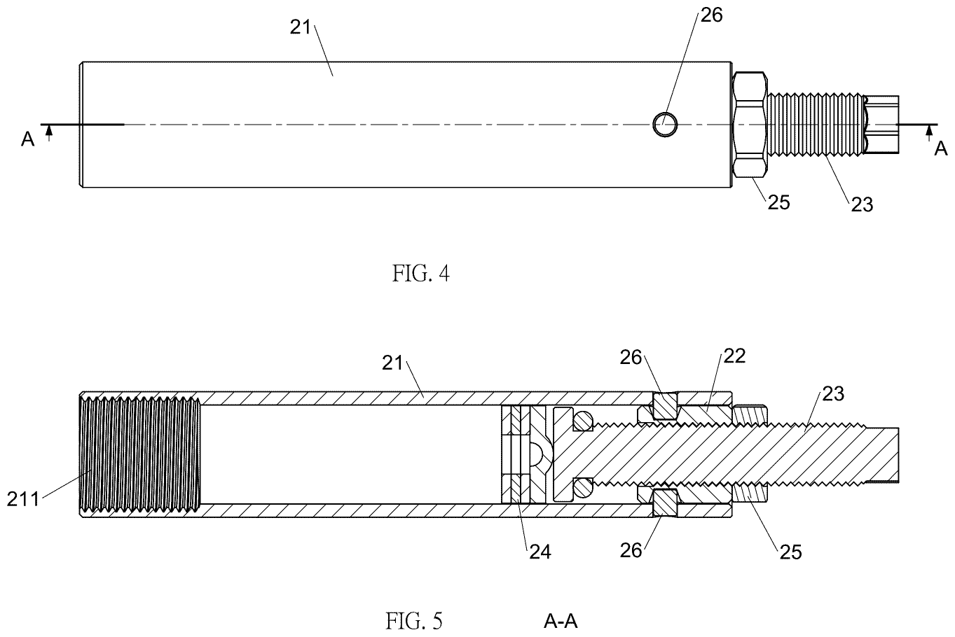

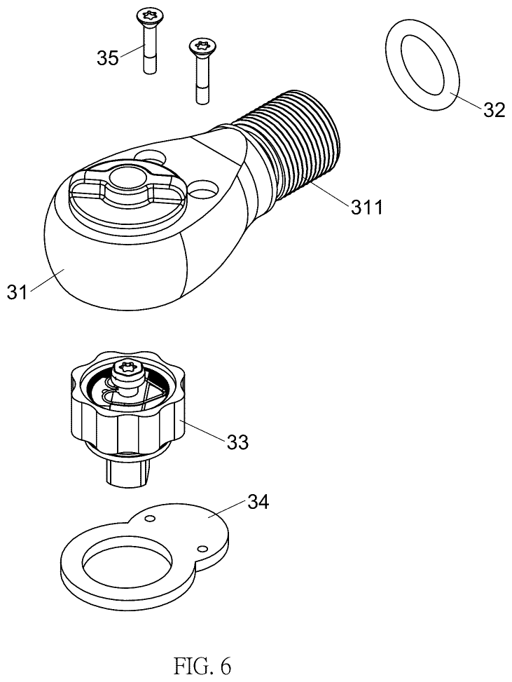

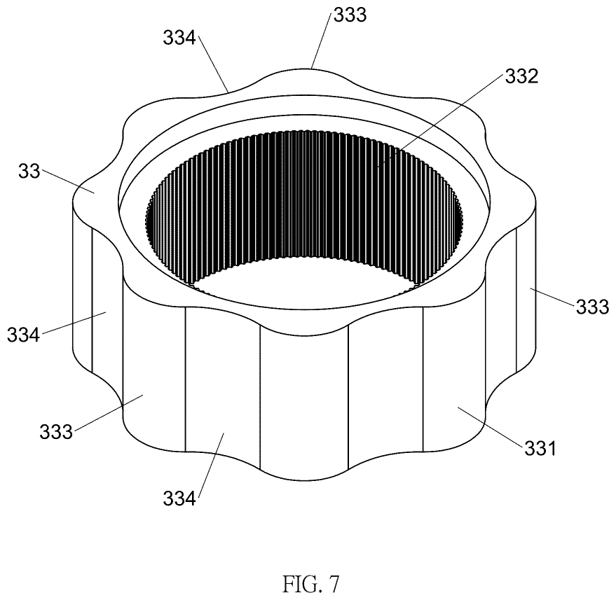

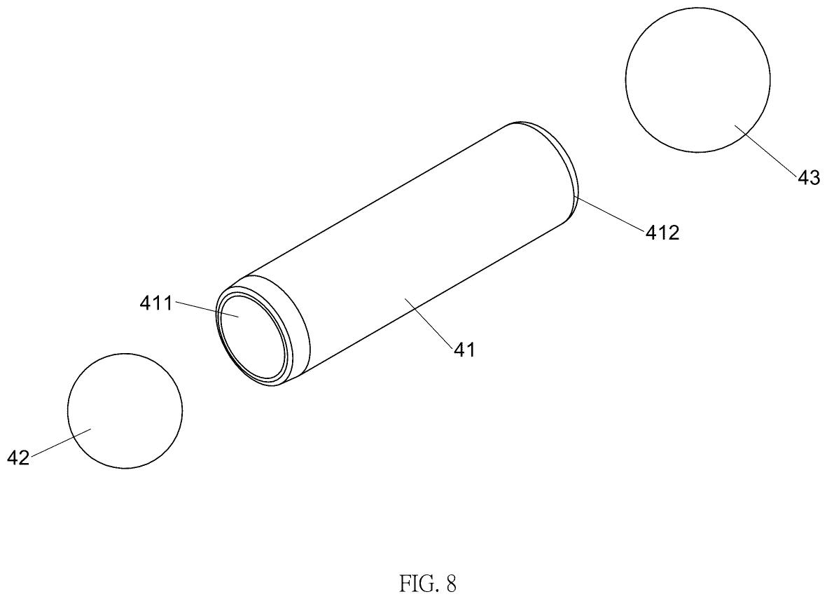

Referring to the drawings and initially to FIGS. 1-9, a torque structure in accordance with the preferred embodiment of the present invention comprises a first body 10, a second body unit 20, a third body unit 30, and a movement unit 40.

The first body 10 is a handle that is held by a user. The first body 10 is made of metal or formed by plastic injection molding. The first body 10 has an interior provided with a first receiving recess 11. The first receiving recess 11 is a circular hole or non-circular hole.

The second body unit 20 is assembled with the first body 10 and partially received in the first receiving recess 11. The second body unit 20 has a tubular shape. The second body unit 20 includes a second body 21, a threaded seat 22, a threaded rod 23, multiple first washers 24, a screw member 25, two first fastening (or fixing) members 26, and an elastic member 28.

The second body 21 is a hollow tube assembled with the first body 10. The second body 21 has a first end having an interior provided with a first threaded portion 211 that is an internal screw hole. The second body 21 has a second end provided with multiple first through holes 212 hidden in the first receiving recess 11. Each of the first through holes 212 has a circular shape and penetrates the second body 21. Preferably, the second body 21 has two first through holes 212 opposite to each other.

The threaded seat 22 is received in the second body 21 and has an interior provided with a second threaded portion 221 that is an internal screw hole. The threaded seat 22 is provided with multiple second through holes 222 aligning with the first through holes 212 respectively. The second through holes 222 have a number equal to that of the first through holes 212. Each of the second through holes 222 penetrates the threaded seat 22. The second through holes 222 are perpendicular and connected to the second threaded portion 221.

The threaded rod 23 is partially hidden in the second body 21 and screwed with the threaded seat 22. The threaded rod 23 is provided with a third threaded portion 231 screwed into the second threaded portion 221. The third threaded portion 231 extends in a lengthwise direction of the threaded rod 23. The threaded rod 23 has a first end provided with a push block 232 that is hidden in the second body 21. The push block 232 has a diameter more than that of the threaded rod 23. The threaded rod 23 has a second end provided with a polygonal head that is driven to rotate the threaded rod 23.

The first washers 24 are received in the second body 21. The first washers 24 include three washers having a flat shape and a washer having a projection. The first washers 24 rest on the push block 232.

The screw member 25 is screwed onto the third threaded portion 231 and rests on the threaded seat 22.

The two first fastening members 26 are received in the first through holes 212 and the second through holes 222 respectively. The two first fastening members 26 restrict the threaded seat 22 in the second body 21 to prevent the threaded seat 22 from being detached from the second body 21.

The elastic member 28 is received in the second body 21. The elastic member 28 has an end pressing the first washers 24. The first washers 24 are pressed between the threaded rod 23 and the elastic member 28.

In practice, a position of the threaded rod 23 relative to the threaded seat 22 is changed to adjust a length of the elastic member 28, and to regulate a torque of the torque structure. When the torque of the torque structure reaches a preset value, the position of the threaded rod 23 relative to the threaded seat 22 is fixed, and the screw member 25 is screwed onto the third threaded portion 231 and presses the threaded seat 22, so that the threaded rod 23 is limited by the screw member 25 and cannot be rotated, and the torque of the torque structure is fixed and cannot be adjusted.

The third body unit 30 is screwed onto the second body unit 20, with the second body unit 20 being located between the first body 10 and the third body unit 30. The third body unit 30 includes a third body 31, a second washer 32, a rotation member 33, a cover 34, and two second fastening (or fixing) members 35.

The third body 31 is provided with a fourth threaded portion 311 screwed with the first threaded portion 211. After the third body 31 is screwed with the second body 21, an adhesive is applied between the fourth threaded portion 311 and the first threaded portion 211, so that the third body 31 and the second body 21 are combined integrally without detachment.

The second washer 32 is mounted on the fourth threaded portion 311 and located between an end portion of the third body 31 and the fourth threaded portion 311. Preferably, the second washer 32 is an O-ring made of soft material.

The rotation member 33 is pivotally mounted in the third body 31. The rotation member 33 has a ring shape and has an exterior provided with a first outer peripheral face 331 and an interior provided with a first inner peripheral face 332. The inner peripheral face 332 has multiple teeth arranged annularly. The outer peripheral face 331 is provided with multiple first protruded portions 333 and multiple first recessed portions 334 which are spaced and arranged annularly. Each of the first recessed portions 334 is located between two of the first protruded portions 333. Each of the first protruded portions 333 has a convex shape with a single arcuate face. Each of the first recessed portions 334 has a concave shape with a single arcuate face. Each of the first protruded portions 333 is tangent to each of the first recessed portions 334.

The cover 34 covers an opening of the third body 31 and rests on the rotation member 33 so that the rotation member 33 is pivotally mounted in the third body 31 without detachment.

The two second fastening members 35 extend through the third body 31 and the cover 34 respectively so that the cover 34 and the rotation member 33 are assembled to the third body 31 without detachment.

The movement unit 40 is received in the third body unit 30 and the second body unit 20. The movement unit 40 includes a moving member 41, a first ball 42, and a second ball 43.

The moving member 41 is received in and partially protrudes from the third body 31. The moving member 41 is movable through a distance in the third body 31. The moving member 41 is a circular rod and has a first end provided with a first abutting portion 411 and a second end provided with a second abutting portion 412. The first abutting portion 411 is a circular groove, and the second abutting portion 412 has a planar shape.

The first ball 42 is received in the third body 31. The first ball 42 and the moving member 41 are movable synchronously through a distance in the third body 31. The first ball 42 aligns with and rests on one of the first protruded portions 333 or one of the first recessed portions 334. The first ball 42 rests on the first abutting portion 411.

The second ball 43 is received in the second body 21 and rests between the elastic member 28 and the second abutting portion 412. Preferably, the second ball 43 rests against a central position of the elastic member 28, so that the movement unit 40 is coaxial with the second body unit 20.

In practice, the third body unit 30 has a torque slip or laterally shiftable effect by cooperation of the elastic member 28 and the movement unit 40.

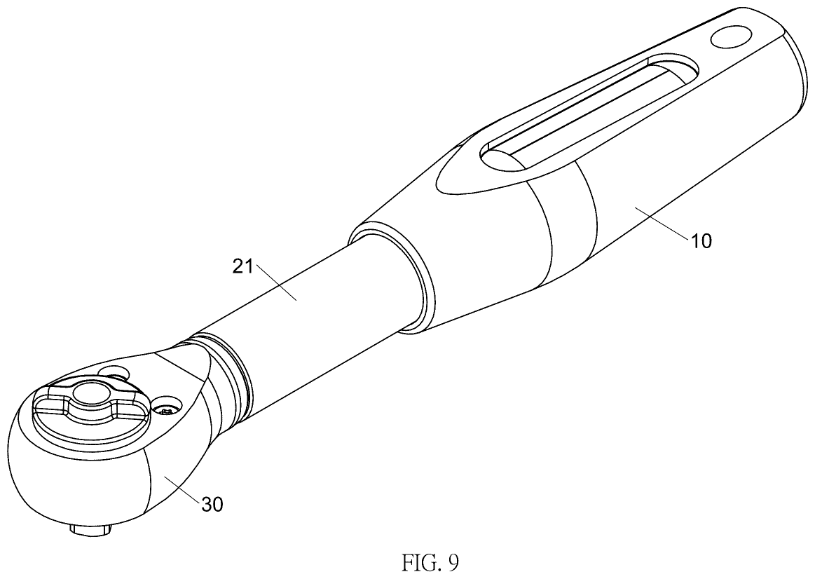

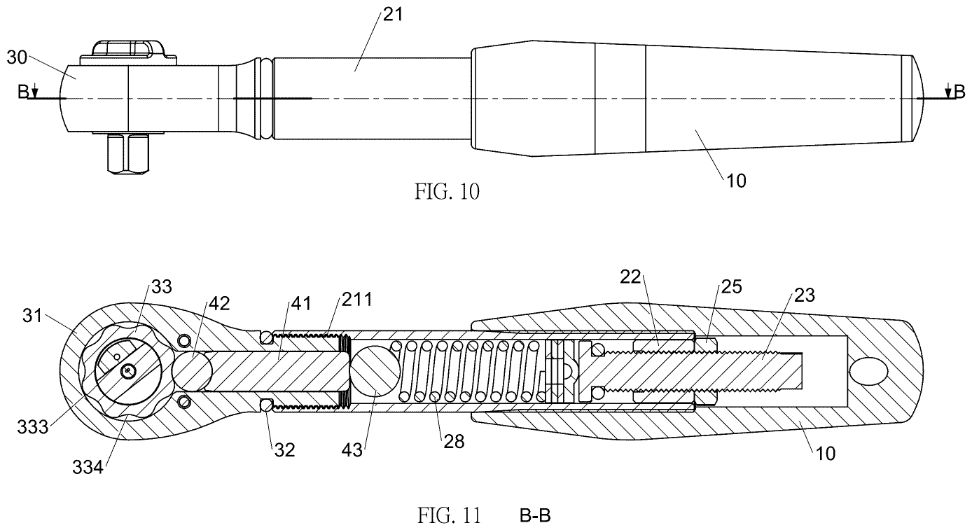

In assembly, referring to FIGS. 9-11 with reference to FIGS. 1-8, the second body unit 20 has a first end assembled with the first body 10. The threaded seat 22 is assembled in the second body 21. The threaded rod 23 is screwed with the threaded seat 22. The screw member 25 is screwed onto the third threaded portion 231 and rests on the threaded seat 22. The elastic member 28 is received in the second body 21. The first washers 24 are pressed between the push block 232 of the threaded rod 23 and the elastic member 28. The third body unit 30 is assembled with a second end of the second body unit 20. The movement unit 40 is received in the third body unit 30 and the second body unit 20. The first ball 42 presses one of the first recessed portions 334. The second ball 43 is pressed between the elastic member 28 and the second abutting portion 412 of the moving member 41.

In operation, when the second body unit 20 is driven and rotated by the first body 10, the third body unit 30 is driven and rotated by the second body unit 20. When the second body unit 20 is driven and rotated by the first body 10 to exceed the preset torque value, the first ball 42 is detached from one of the first recessed portions 334, so that the rotation member 33 is not driven by the first ball 42. The first ball 42 is moved on the outer peripheral face 331 and presses one of the first protruded portions 333, and the movement unit 40 compresses the elastic member 28. At this time, the first ball 42, the moving member 41, and the second ball 43 are moved in the third body 31 and the second body 21. When the second body unit 20 is rotated successively by the first body 10, the first ball 42 slides into another one of the first recessed portions 334 and generates a sound, so that the third body unit 30 has a torque slip effect.

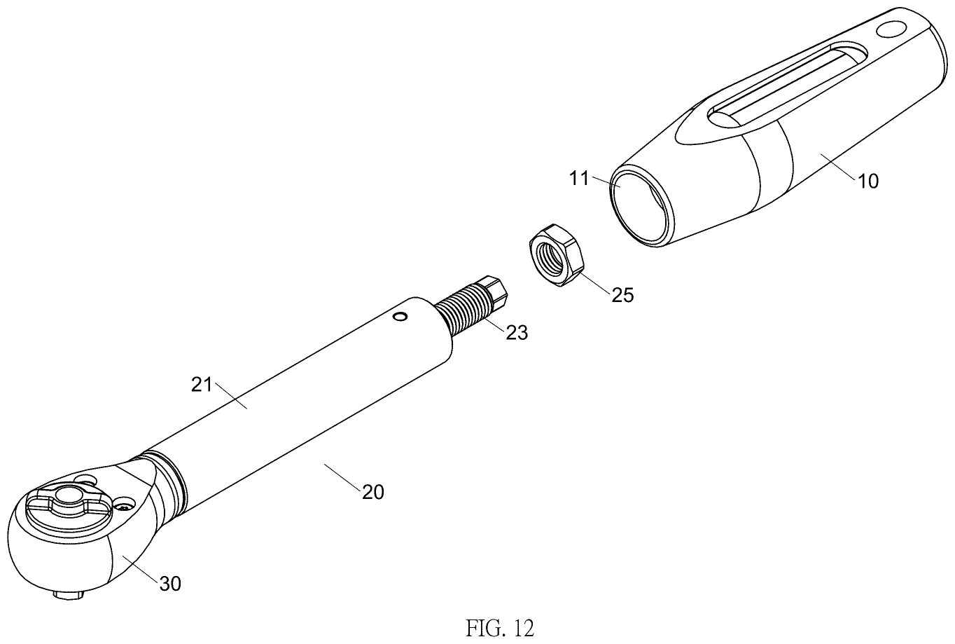

Referring to FIG. 12 with reference to FIGS. 1-11, after the second body unit 20 and the third body unit 30 are assembled, the threaded rod 23 is rotated to adjust the torque. When adjustment of the torque is finished, the screw member 25 is screwed onto the third threaded portion 231 of the threaded rod 23. Thus, the screw member 25 is locked and presses the threaded seat 22, so that the threaded rod 23 is positioned and cannot be rotated to adjust the torque anymore. Then, the second body unit 20 is mounted in the first body 10 to construct the torque structure with a constant torque.

Accordingly, the torque structure of the present invention has the following advantages.
1. The third body unit 30 is assembled with the second body unit 20. The second body 21 is a hollow tube that is worked easily. The second body 21 is only worked to form the first threaded portion 211 and the first through holes 212, thereby reducing the working cost.
2. The third body 31 is only worked to form the fourth threaded portion 311 that is screwed into the first threaded portion 211. Thus, the fourth threaded portion 311 is assembled with the first threaded portion 211 quickly.
3. The second ball 43 rests against the elastic member 28. The elastic member 28 has a ring shape so that the second ball 43 aligns with the elastic member 28 easily. Thus, the axis of the movement unit 40 aligns with that of the elastic member 28 easily, to reduce an axis deviation between the movement unit 40 and the elastic member 28, and to prevent an error of torque.
4. After the second body unit 20 and the third body unit 30 are assembled, the threaded rod 23 is rotated to adjust the torque. When the torque is adjusted to the required value, the screw member 25 is screwed onto the third threaded portion 231 of the threaded rod 23. Thus, the screw member 25 presses the threaded seat 22, so that the threaded rod 23 is positioned and cannot be rotated to adjust the torque anymore. Then, the second body unit 20 is mounted in the first body 10 to construct the torque structure with a constant torque.
5. The first body 10 is mounted on the second body unit 20 after the torque is adjusted, so that the first body 10 only needs to align with the third body unit 30 during assembly, to prevent an appearance misalignment of the torque structure.
6. When the second body unit 20 is driven by the first body 10 to exceed the preset torque, the rotation member 33 will rotate relative to the movement unit 40. Thus, one of the first protruded portions 333 pushes and moves the movement unit 40 which compresses the elastic member 28, so that the third body unit 30 has a torque slip effect.
7. When the second body unit 20 is screwed onto the third body unit 30, the movement unit 40 is biased between the rotation member 33 and the elastic member 28, so that the movement unit 40 is movable. Thus, the second body unit 20 saves the cost and is available for other third body units 30 of different types.
8. The principle of the present invention is characterized in that, the third body unit 30 has a torque slip effect only when the movement unit 40 is moved. The moving member 41 of the movement unit 40 is biased between the rotation member 33 and the elastic member 28, so that the movement unit 40 is movable. The second body unit 20 is screwed onto the third body unit 30. Thus, the second body unit 20 is shared and can be assembled with different third body units 30 to provide a double function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A torque structure comprising:
a first body, a second body, a third body unit, and a movement unit;
wherein:
the first body has an interior provided with a first receiving recess;
the second body unit is assembled with the first body and partially received in the first receiving recess;
the second body unit has a tubular shape;
the second body unit includes a second body, a threaded seat, a threaded rod, multiple first washers, a screw member, two first fastening members, and an elastic member;
the second body is a hollow tube assembled with the first body;
the second body has a first end having an interior provided with a first threaded portion that is an internal screw hole;
the second body has a second end provided with multiple first through holes hidden in the first receiving recess;
each of the first through holes has a circular shape and penetrates the second body;
the threaded seat is received in the second body and has an interior provided with a second threaded portion that is an internal screw hole;
the threaded seat is provided with multiple second through holes aligning with the first through holes respectively;
the second through holes have a number equal to that of the first through holes;
each of the second through holes penetrates the threaded seat;
the second through holes are perpendicular and connected to the second threaded portion;
the threaded rod is partially hidden in the second body and screwed with the threaded seat;
the threaded rod is provided with a third threaded portion screwed into the second threaded portion;
the third threaded portion extends in a lengthwise direction of the threaded rod;
the threaded rod has a first end provided with a push block that is hidden in the second body;
the push block has a diameter more than that of the threaded rod;
the threaded rod has a second end provided with a polygonal head that is driven to rotate the threaded rod;
the first washers are received in the second body;
the first washers include three washers having a flat shape and a washer having a projection;
the first washers rest on the push block;
the screw member is screwed onto the third threaded portion and rests on the threaded seat;
the two first fastening members are received in the first through holes and the second through holes respectively;
the two first fastening members restrict the threaded seat in the second body to prevent the threaded seat from being detached from the second body;
the elastic member is received in the second body;
the elastic member has an end pressing the first washers;
the first washers are pressed between the threaded rod and the elastic member;
a position of the threaded rod relative to the threaded seat is changed to adjust a length of the elastic member, and to regulate a torque of the torque structure;
when the torque of the torque structure reaches a preset value, the position of the threaded rod relative to the threaded seat is fixed, and the screw member is screwed onto the third threaded portion and presses the threaded seat, so that the threaded rod is limited by the screw member and cannot be rotated, and the torque of the torque structure is fixed and cannot be adjusted;
the third body unit is screwed onto the second body unit, with the second body unit being located between the first body and the third body unit;
the third body unit includes a third body, a second washer, and a rotation member;
the third body is provided with a fourth threaded portion screwed with the first threaded portion;
the second washer is mounted on the fourth threaded portion and located between an end portion of the third body and the fourth threaded portion;
the second washer is made of soft material;
the rotation member is pivotally mounted in the third body;
the rotation member has a ring shape and has an exterior provided with a first outer peripheral face and an interior provided with a first inner peripheral face;
the inner peripheral face has multiple teeth arranged annularly;
the outer peripheral face is provided with multiple first protruded portions and multiple first recessed portions which are spaced and arranged annularly;
each of the first recessed portions is located between two of the first protruded portions;
each of the first protruded portions has a convex shape with a single arcuate face;
each of the first recessed portions has a concave shape with a single arcuate face;
each of the first protruded portions is tangent to each of the first recessed portions;
the movement unit is received in the third body unit and the second body unit;
the movement unit includes a moving member, a first ball, and a second ball;
the moving member is received in and partially protrudes from the third body;
the moving member is movable through a distance in the third body;
the moving member is a circular rod and has a first end provided with a first abutting portion and a second end provided with a second abutting portion;
the first abutting portion is a circular groove, and the second abutting portion has a planar shape;
the first ball is received in the third body;
the first ball and the moving member are movable synchronously through a distance in the third body;
the first ball aligns with and rests on one of the first protruded portions or one of the first recessed portions;
the first ball rests on the first abutting portion;
the second ball is received in the second body and rests between the elastic member and the second abutting portion;
the second ball rests against a central position of the elastic member, so that the movement unit is coaxial with the second body unit; and
the third body unit has a torque slip effect by cooperation of the elastic member and the movement unit.

2. The torque structure as claimed in claim 1, wherein:
the first body is held by a user;
the first body is made of metal or formed by plastic injection molding; and
the first receiving recess is a circular hole or non-circular hole.

3. The torque structure as claimed in claim 1, wherein the second body has two first through holes opposite to each other.

4. The torque structure as claimed in claim 1, wherein after the third body is screwed with the second body, an adhesive is applied between the fourth threaded portion and the first threaded portion, so that the third body and the second body are combined integrally without detachment.

5. The torque structure as claimed in claim 1, wherein:
the third body unit further includes a cover, and two second fastening members;
the cover covers an opening of the third body so that the rotation member is pivotally mounted in the third body without detachment; and
the two second fastening members extend through the third body and the cover respectively so that the cover and the rotation member are assembled to the third body without detachment.

6. The torque structure as claimed in claim 1, wherein:
when the second body unit is driven and rotated by the first body to exceed the preset torque value, the first ball is detached from one of the first recessed portions;
the first ball is moved on the outer peripheral face and presses one of the first protruded portions, and the movement unit compresses the elastic member; and
when the second body unit is rotated successively by the first body, the first ball slides into another one of the first recessed portions and generates a sound, so that the third body unit has a torque slip effect.

7. The torque structure as claimed in claim 1, wherein:
after the second body unit and the third body unit are assembled, the threaded rod is rotated to adjust the torque;
when adjustment of the torque is finished, the screw member is screwed onto the third threaded portion of the threaded rod;
the screw member is locked and presses the threaded seat, so that the threaded rod is positioned and cannot be rotated to adjust the torque; and
the second body unit is mounted in the first body to construct the torque structure with a constant torque.
